(19) United States
(12) Patent Application Publication
(10) Pub. No.: US 2026/0113168 A1
(43) Pub. Date: Apr. 23, 2026

(54) Processing Preamble Puncture in an Access Point

(71) Applicant: Arista Networks, Inc., Santa Clara, CA (US)

(72) Inventors: Nihar Ranjan BEHERA, Pune (IN); Nishant Nityanand MALLYA, Pune (IN); Jatin Jayendra PAREKH, Mumbai (IN)

(21) Appl. No.: 18/922,804

(22) Filed: Oct. 22, 2024

(51) Int. Cl. H04L 5/00; H04W 48/02

(52) U.S. Cl. CPC H04L 5/006; H04L 5/0007; H04L 5/0094; H04W 48/02

(57) ABSTRACT

A method for responding to an association request from a non-Wi-Fi 7 Client in the presence of a punctured channel includes accepting the association request when the Client cannot operate on any other channel. When the Client can operate on other channels, the association request is accepted when the usable bandwidth on the punctured channel is greater than or equal to the usable bandwidth on all the other channels that the Client can operate on. Otherwise the association request is rejected, with the goal that the Client will resend the association request on one of its other channels which has a higher usable bandwidth.

### CROSS REFERENCE TO RELATED APPLICATIONS

This application is related to concurrently filed U.S. App. No. TBD, Applicant Ref. No. 000200-036900US, and is incorporated herein by reference in its entirety for all purposes.

This application is related to U.S. application Ser. No. 17/733,416, filed Apr. 29, 2022, titled “Resource Unit Puncturing and Allocation Based On Quality Metrics” and to U.S. application Ser. No. 18/422,336, filed Jan. 25, 2024, titled “Dynamic Preamble Puncturing in Wi-Fi Devices”, the content of both of which is incorporated herein by reference in its entirety for all purposes.

### BACKGROUND

Preamble puncturing is a feature supported by the Wi-Fi 7 (IEEE 802.11be) standard and the Wi-Fi 6 (IEEE 802.11ax) standard that enables Wi-Fi devices to carve out, or “puncture,” certain portions (i.e., subchannels) of a wireless channel on which the devices operate. By puncturing a subchannel of a wireless channel, a Wi-Fi device can avoid using the radio frequency (RF) spectrum corresponding to the punctured subchannel for Wi-Fi transmissions while continuing to use the remaining channel spectrum.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 is an illustrative Wi-Fi environment.

FIG. 2 is high-level representation of an access point (AP) in accordance with the present disclosure.

FIG. 3 shows a Wi-Fi controller in accordance with the present disclosure.

FIGS. 4A, 4B, 4C are examples of a channel configuration.

FIG. 5 represents a flow of operations in accordance with an aspect of the present disclosure.

FIG. 6 is an example illustrating operations in accordance with an aspect of the present disclosure.

FIG. 7 represents a flow of operations in accordance with an aspect of the present disclosure.

FIGS. 8A, 8B, 9A, 9B are examples illustrating operations in accordance with an aspect of the present disclosure.

### DETAILED DESCRIPTION

Channel Puncture vs. Bandwidth Reduction An aspect of the present disclosure is directed to reducing channel interference between an access point (AP) and a client device (Client, also referred to as a station) in a Wi-Fi network. Preamble puncturing allows users (APs and Clients) of Wi-Fi 7 to communicate over noisy channels by avoiding noisy subchannels (e.g., 20/40/80 MHz) while continuing to transmit and receive on the remaining subchannels.

However, there may be circumstances where a significant amount of interference is still present on the subchannels outside of the puncture pattern. In such situations, Wi-Fi 7 allows the AP and Client to obtain a different puncture pattern. Depending on the channel conditions, the AP and Client may attempt several retries at a suitable puncture pattern before arriving at a final configuration for the channel. Reaching the final channel configuration may involve numerous iterations, causing a noticeable delay before establishing communication between the AP and Client.

Embodiments in accordance with the present disclosure avoid this “retry” delay using a heuristic for choosing a channel configuration of usable subchannels by iterating between puncturing the channel (channel puncture) and halving the operating bandwidth of the channel (bandwidth reduction). As used herein, the “channel configuration” of channel refers to the usable subchannels in the channel after channel puncture or bandwidth reduction.

The choice between channel puncturing and bandwidth reduction can be based on interference metrics associated with each subchannel that indicate the channel conditions of the subchannel; e.g., utilization, interference, noise, signal strength, the presence of radar, etc. The AP can apply the heuristic upfront as part of responding to an association request from the Client. Embodiments in accordance with the present disclosure also include the AP repeatedly running the heuristic on existing associations with the goal to maximize available bandwidth for transmission and reception as conditions in the radio environment degrade or improve.

In accordance with the present disclosure, the heuristic attempts to identify a valid puncture pattern to eliminate the interfering subchannels. If there is no valid puncture pattern, then the channel bandwidth may be halved. The heuristic is repeated on the primary half of the halved channel, namely the half that contains the primary operating subchannel. The basic flow proceeds as follows:
Receive channel conditions (interference) metrics for each subchannel
Are there any “interfering” subchannels where their interference metrics exceed interference threshold?
   No→use current channel configuration, DONE.
   Yes→continue.
Is there a valid puncture pattern that covers all the interfering subchannels?
   Yes→apply puncture pattern and use resulting channel configuration, DONE.
   No→continue.
Can we reduce channel bandwidth by half?
   No→use current channel configuration, DONE.
   Yes→continue.
Reduce channel bandwidth by half; keep the half that has the primary channel (primary half).
Repeat.
   In some embodiments, the heuristic can be triggered aperiodically to run, for example, in response to asynchronous events such as when receiving and responding to an association request from a Client. The heuristic can also be triggered to run on a periodic basis; e.g., every x number of minutes.

Preamble Puncture Nudging Another aspect of the present disclosure is directed to accommodating non-Wi-Fi 7 Clients operating in a Wi-Fi 7-enabled radio environment. Non-Wi-Fi 7 Clients do not operate in accordance with either the Wi-Fi 7 standard or the Wi-Fi 6 standard and so do not recognize, and cannot, utilize all the usable subchannels of a punctured channel. When a non-Wi-Fi 7 Client associates with an AP on a channel that is punctured, the Client can only use the portion of the channel bandwidth (the usable bandwidth) that includes the primary channel up to the first punctured subchannel closest to the primary channel. In some circumstances, however, the non-Wi-Fi 7 Client may have better performance in a channel in another frequency band as compared to the frequency band of the punctured channel.

When a Wi-Fi 7 AP receives an association request from a non-Wi-Fi 7 Client on an operating channel of the AP, preamble puncture nudging in accordance with the present disclosure includes:
If the operating channel has not been punctured, the AP will accept the association request. If the operating channel is punctured and the Client cannot transmit on another channel in another frequency band, the AP will accept the association request.
If the operating channel is punctured and the resulting usable bandwidth of the punctured channel is less than the usable bandwidth of a channel in another frequency band that the Client can transmit in, the AP will reject the association request. The intended effect is to cause (“nudge”) the Client to resend the association request on the other channel.
On the other hand, if the operating channel is punctured and the resulting usable bandwidth of the punctured channel is greater than the bandwidth of all other channels in the other frequency bands that the Client can transmit in, the AP will accept the association request and the non-Wi-Fi 7 Client will transmit on the usable bandwidth of the punctured channel.

The Wi-Fi standards currently recognize only three frequency bands: 2.4 GHz, 5 GHz, and 6 GHz, although it will be appreciated, in principle, the invention can accommodate additional bands.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

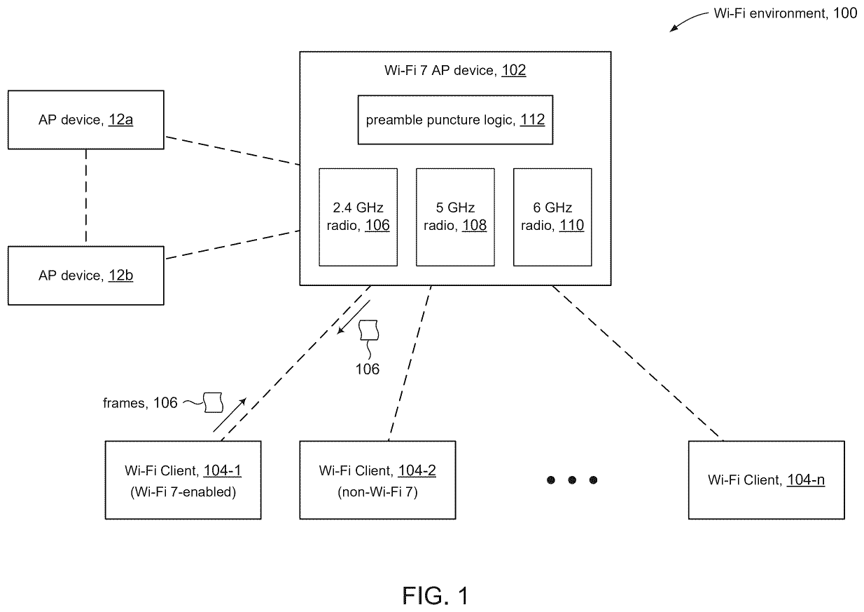

FIG. 1 is a simplified block diagram of an example Wi-Fi radio environment 100 in which the techniques of the present disclosure can be implemented. As shown, environment 100 includes a Wi-Fi 7-enabled access point (AP) 102 that is wirelessly coupled with a number of Wi-Fi client devices (Clients) 104-1, 104-2, . . . 104-n, collectively referenced as 104. Wi-Fi is a wireless networking technology that is standardized via a set of IEEE (Institute of Electrical and Electronics Engineers) standards known as the IEEE 802.11x standards. The most recent version of this technology is Wi-Fi 7, which is defined in the IEEE 802.11be standard. Earlier versions include Wi-Fi 6 (IEEE 802.11ax), Wi-Fi 5 (IEEE 802.11ac), and so on. Although AP 102 is described as a Wi-Fi 7 device, it will be appreciated that in alternative embodiments AP 102 may be a Wi-Fi 6/6E device or a Wi-Fi device implementing some other/future Wi-Fi version that supports preamble puncturing.

Clients 104 can be Wi-Fi 7-enabled devices (i.e., operate in accordance with Wi-Fi 7) or non-Wi-Fi 7 devices (i.e., do not operate in accordance with Wi-Fi 7). Merely for illustration purposes, FIG. 1 shows that Client 104-1 is Wi-Fi 7-enabled and Client 104-2 is non-Wi-Fi 7.

In some embodiments, AP 102 can support Wi-Fi transmissions over three wireless frequency bands per the Wi-Fi 7 standard: a 2.4 gigahertz (GHz) frequency band, a 5 GHz frequency band, and a 6 GHz frequency band. For example, AP 102 includes a 2.4 GHz radio 106 dedicated for sending/receiving Wi-Fi signals over the 2.4 GHz band, a 5 GHz radio 108 dedicated for sending/receiving Wi-Fi signals over the 5 GHz band, and a 6 GHz radio 110 dedicated for sending/receiving Wi-Fi signals over the 6 GHz band. It is also possible for AP 102 to have multiple radios per frequency band. Each frequency band corresponds to a range of the RF spectrum that has been licensed for Wi-Fi use. In the United States, the 2.4 GHz band covers the RF range of 2400 to 2495 megahertz (MHz), the 5 GHz band covers the RF range of 5170 to 5835 MHz, and the 6 GHz band covers the RF range of 5925 to 7125 MHz.

For each radio 106/108/110, AP 102 selects and uses a wireless channel (hereinafter simply “channel”) within that radio's frequency band for communicating with Wi-Fi Clients 104-1 to 104-n. The channel uses a specific subrange of frequencies in the frequency band that the radio can operate on at a given point in time. While the exact number of channels available in each wireless band varies based on regional regulatory standards and the Wi-Fi version being used, the 5 GHz and 6 GHz bands have more available channels than the 2.4 GHz band due to their larger spectrum sizes. Further, the width of each channel in the 2.4 band is limited to 20 MHz or 40 MHz, whereas the widths of the channels in the 5 GHz band range from 20 MHz to 160 MHz and the widths of the channels in the 6 GHz band range from 20 MHz to 320 MHz.

Generally speaking, wider channels provide a higher data throughput rate (i.e., bandwidth) than narrower channels because bandwidth scales with channel width. Accordingly, it may be preferable for AP 102 to select and use wide channels on the 5 GHz and 6 GHz bands whenever possible. However, a wide channel is more frequently affected by RF interference and other conflicts (e.g., RADAR activity) than a 20 MHz channel because it spans a larger RF range. This can adversely affect the performance of the wide channel as a whole and in some cases can knock the entire channel out of service.

Environment 100 can include RF neighbors, such as AP devices 12a, 12b. The neighbor AP devices can be Wi-Fi 7-enabled or not Wi-Fi 7-enabled. AP devices 102, 12a, 12b can share information with each other (e.g., wirelessly or by wired connections) regarding the RF conditions of environment 100, including information such as but not limited to, received signal strength indicators (RSSIs), congestion, channel utilization, and other statistics and metrics. AP 102 can include preamble puncture logic 112 that uses any such information that the AP has collected (and/or computed) to assess channel conditions in environment 100 for processing in accordance with the present disclosure.

Clients 104 manage their connection to an AP by exchanging frames 106. Such frames are defined by the IEEE 802.11x standards and are well understood. Briefly, some frames 106 used in embodiments of the present disclosure include:
Beacon frame: The AP periodically sends a beacon to announce its presence and relay various information that is required by the Clients to connect to the wireless network.
Probe Request frame: The Client sends a probe request to discover available APs in environment 100. APs that receive the probe request may respond with a probe response.
Probe Response frame: The AP responds to a probe request by sending a probe response, advertising its SSID (service set identifier), supported data rates, and other information.
Association Request frame: The Client sends an association request to the AP to request association with the AP.
Association Response frame: The AP responds to an association request by sending an association response that either grants or denies the request for association.

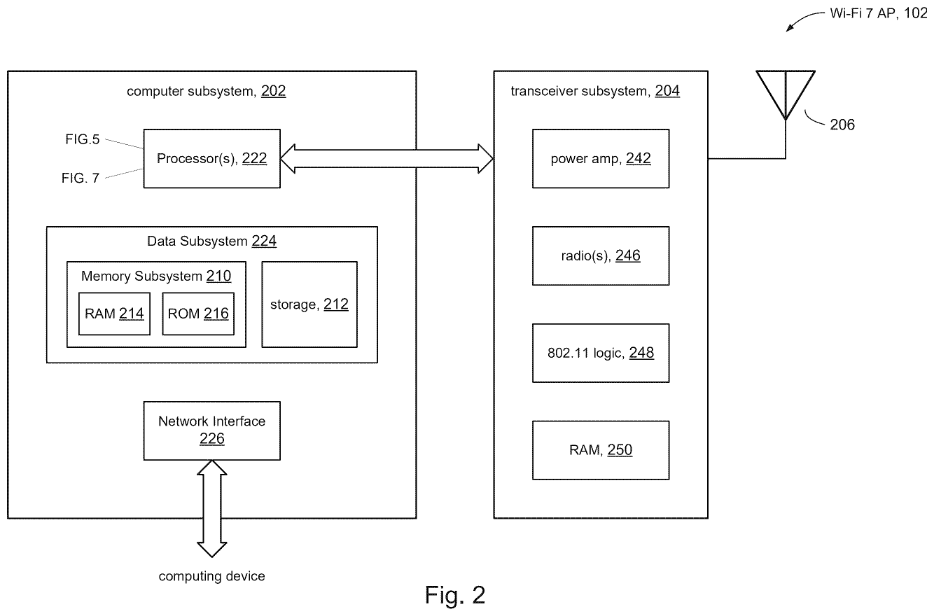

FIG. 2 is a high-level representation of AP 102 in accordance with some embodiments. AP 102 can comprise computer subsystem 202, transceiver subsystem 204, and antenna 206. Computer subsystem 202 can include one or more processors 222, a data subsystem 224, and a network interface 226. Processor(s) 222 can be in communication with transceiver subsystem 204 to configure the transceiver subsystem and otherwise control operations of the transceiver. Data subsystem 224 can include memory subsystem 210 and storage subsystem 212. Memory subsystem 210 in turn can include memory components such as random access memory (RAM) 214 for storage of instructions and data during program execution, and read-only memory (ROM) 216 in which fixed instructions are stored. Storage subsystem 212 can provide persistent (i.e., non-volatile) storage for program and data files. Storage subsystem 212 can represent non-transitory computer-readable storage media to store program code and/or data, which when executed by processors 222, can cause the processors to perform operations in accordance with embodiments of the present disclosure. Network interface subsystem 226 can serve as an interface for communication with other computer systems (e.g., Wi-Fi controller 302, switches, etc.).

Transceiver subsystem 204 can include a power amplifier 242, a radio component 246, IEEE 802.11 logic 248, and RAM 250. Power amplifier 242 can provide power to radio 246 (e.g., one or more radios 106, 108, 110), for example, in order to transmit and receive signals via antenna 206. IEEE 802.11 logic 248 can comprise data processing elements such as an ASIC (application specific integrated circuit), FPGA (field programmable gate array), digital processing unit, and the like. Logic 248 can be configured to process signals (received and for transmission) in accordance with the IEEE 802.11 standards, including IEEE 802.11be (Wi-Fi 7) and IEEE 802.11ax (Wi-Fi 6). RAM 250 can provide buffers, queues, and other data structures to support the transmission and reception of data.

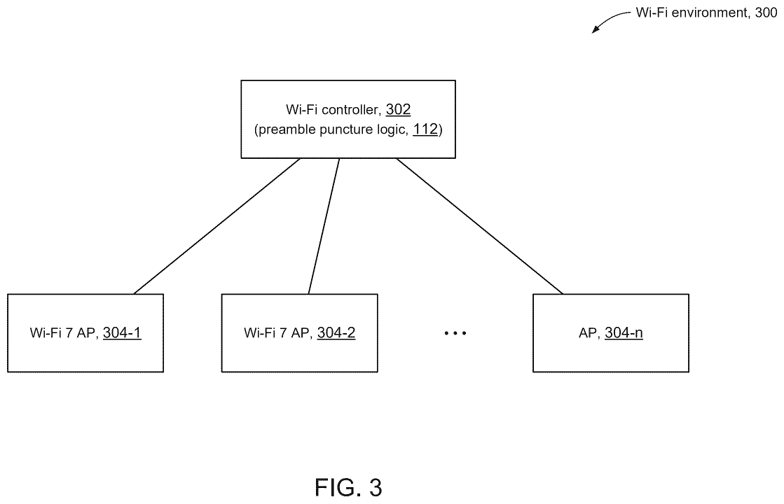

While FIG. 1 shows the preamble puncturing logic 112 is incorporated in AP 102. In other embodiments, the preamble puncturing logic 112 can be incorporated in a computer system that is configured to manage a cluster of Wi-Fi APs. FIG. 3, for example, shows an environment 300 comprising Wi-Fi controller 302 that is configured to manage Wi-Fi AP devices 304-1, 304-2, . . . 304-n (collectively 304). APs 304 can be Wi-Fi 7-enabled or not; for example APs 304-1, 304-2 are Wi-Fi 7-enabled. Wi-Fi controller 302 can instantiate a separate instance of preamble puncturing logic 112 for each of the APs 304 in order to offload preamble puncture processing of the present disclosure from those APs.

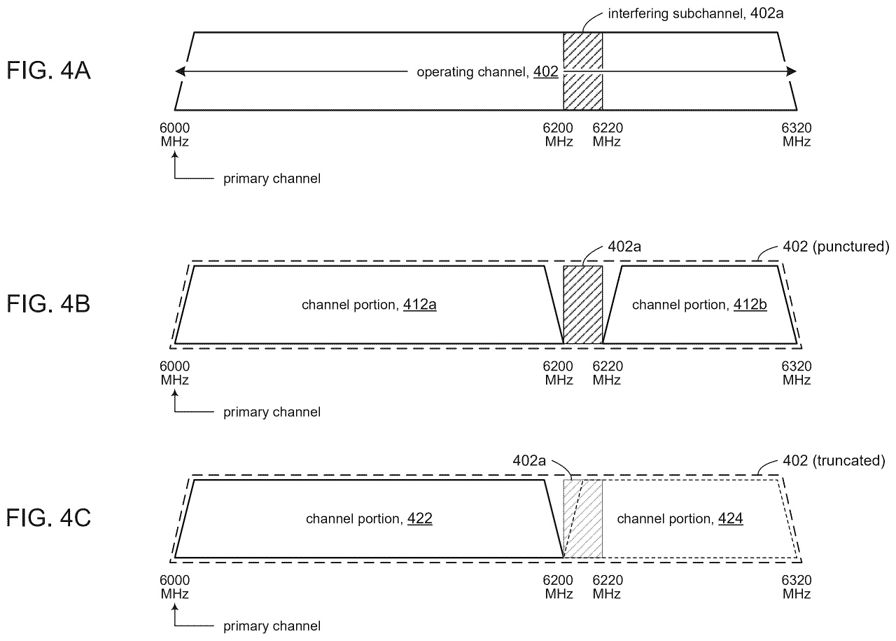

FIGS. 4A, 4B, and 4C illustrate examples of bandwidth utilization in the presence of interfering subchannels in accordance with Wi-Fi 7-enabled Clients and non-Wi-Fi 7 Clients. It will be understood that the examples in FIG. 4A-4C are merely illustrative and not intended to represent an actual channel. FIG. 4A represents an example of an operating channel 402, having a 320 MHz bandwidth from 6 GHz to 6.32 GHz comprising sixteen 20 MHz subchannels, with the primary channel operating at 6000 MHz.

Suppose for discussion purposes, channel 402 exhibits narrow-band interference in subchannel 402a, which in the example is shown to occur in a 20 MHz subchannel from 6200 MHz to 6220 MHz. Suppose further that the narrow-band interference in subchannel 402a is so severe that a Wi-Fi 7-enabled AP device (e.g., 102) has determined the full 320 MHz bandwidth of channel 402 cannot be used for communication with any Clients and has punctured the channel 402 by removing subchannel 402a.

FIG. 4B represents a channel configuration that can result when the AP associates with a Wi-Fi 7-enabled Client (e.g., Client 104-1) on the punctured channel 402. The punctured channel 402 is the resulting operating channel over which the AP and the Wi-Fi 7-enabled Client can communicate. The punctured channel 402 comprises non-punctured channel portions 412a, 412b. The interfering 20 MHz subchannel 402a is punctured (not used). The remaining channel portions 412a, 412b have a combined bandwidth of 300 MHz. The channel configuration of punctured channel 402 in this use case comprises ten usable subchannels in channel portion 412a and five usable subchannels in channel portion 412b.

FIG. 4C represents a channel configuration that can result when a Wi-Fi 7 AP associates with a non-Wi-Fi 7 Client (e.g., Client 104-2). In this use case, the Wi-Fi 7 AP also punctures the channel 402, leaving non-punctured channel portions 422, 424. However, the non-Wi-Fi 7 Client can only use the portion of the original bandwidth of channel 402 that includes the primary channel (a 20 MHz or 40 MHz band) up to the first punctured subchannel closest to the primary channel. In effect, channel 402 is truncated into a usable portion and a non-usable portion. The truncated channel 402 is the resulting operating channel over which the AP and the non-Wi-Fi 7 Client communicate.

For the example shown in FIG. 4C, the primary channel is at 6000 MHz. The usable portion of the bandwidth for a non-Wi-Fi 7 Client is in the 6 GHz to 6.2 GHz frequency range (channel portion 422) because it is the portion of the original bandwidth of channel 402 which includes the primary channel up to the first punctured subchannel (402a) closest to the primary channel. Channel portion 424, which includes the punctured subchannel 402a will not be used. Channel 402 is truncated into a usable portion (e.g., portion 422) and a non-usable portion (e.g., portion 424). The channel configuration of truncated channel 402 in this example comprises the ten usable subchannels in channel portion 422, leaving ten channels unusable.

### Channel Puncture vs. Bandwidth Reduction

As described above, an aspect of the present disclosure is selecting a channel configuration for the channel the AP is operating with, in response to the presence of interference among subchannels of the operating channel. The selection of a suitable channel configuration can be made by choosing between puncturing the operating channel (channel puncturing) and reducing the bandwidth of the operating channel (bandwidth reduction) based on the interference.

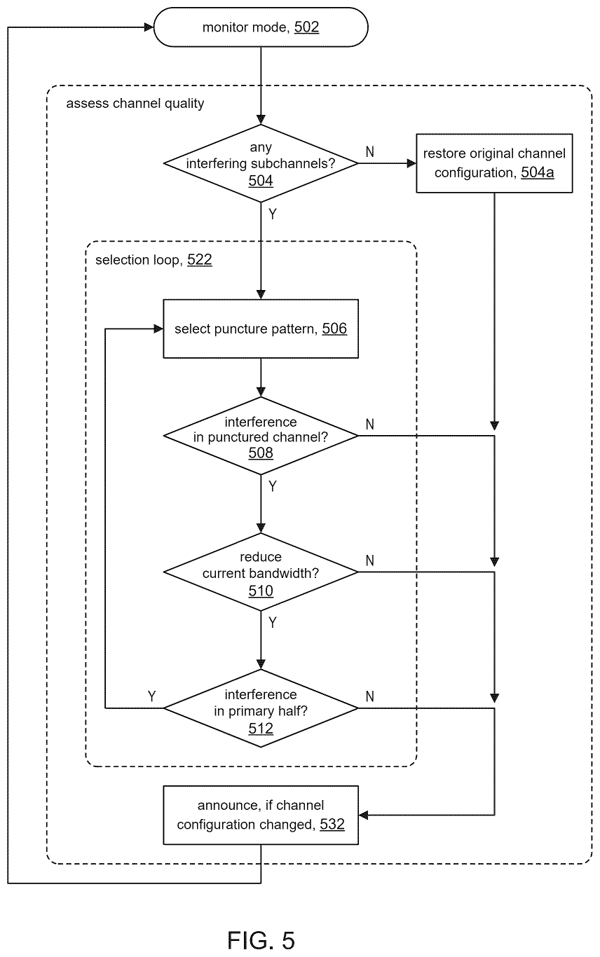

Referring to FIG. 5, the discussion will now turn to a high level description of processing in a Wi-Fi AP (FIG. 2) or in a Wi-Fi controller (FIG. 3) to perform pattern puncture vs. bandwidth reduction processing in accordance with the present disclosure. In some embodiments, for example, the AP can include computer executable program code (e.g., stored on a non-transitory computer-readable storage memory device), which when executed by a processor (e.g., 222, FIG. 2), can cause the computer system to perform the processing represented in FIG. 5. It will be appreciated that the processing blocks in FIG. 5 are merely representative of processing in accordance with the present disclosure. Actual operations and the flow and sequencing of those operations in a given implementation in accordance with the present disclosure will not necessarily correspond one-to-one with the processing blocks in FIG. 5.

At block 502, the AP can operate in a monitoring mode where the AP continuously collects information indicative of the RF conditions in the environment (e.g., radio environment 100) in which the AP is operating. In some embodiments, for example, the AP can compute RF condition metrics based on detected radio signals. The AP can continuously exchange RF condition information with its RF neighbors (e.g., 12a, 12b, FIG. 1). The AP can receive RF condition information from a central Wi-Fi controller (e.g., 302), and so on. The AP can store this collected information to maintain a current state of the RF conditions of its environment, to accumulate historical data for trend analysis, and so on.

The AP can continue to operate in monitoring mode until a trigger event occurs. Trigger events can include aperiodic events such as receiving an association request from a Client. Trigger events can be periodic such as expiration of a timer; e.g., a 30 second timer. In accordance with the present disclosure, when a trigger event occurs the AP can proceed to block 504 to begin a round of assessing the quality of the channel on which the AP is operating (operating channel). In an AP that has multiple radios operating with multiple channels, the AP can run a round of assessing channel quality for each of the multiple channels.

At block 504, the AP can determine if there are any interfering subchannels in the current bandwidth of the operating channel. In some embodiments, a subchannel can be deemed to be “interfering” if the channel conditions (e.g., channel utilization, interference, noise, signal strength, etc.) exceed one or more interference thresholds. The AP can assess the channel conditions of each subchannel using, for example, the monitored RF conditions, its own computed metrics, and so on. For example, if the channel utilization of a subchannel exceeds a threshold percentage (e.g., 75% utilization), the subchannel can be deemed to exhibit interference and can be marked or otherwise identified as being an interfering subchannel for removal from the operating channel. It will be appreciated that the criteria for determining interfering subchannels is not limited to comparing against a single threshold. In various embodiments, the determination can be based on any suitable criteria such as: using multiple thresholds, taking into consideration the availability of valid puncture patterns, the coverage provided by valid puncture patterns, whether subchannels have already been punctured, the bandwidth of the operating channel, and so on. It will be appreciated that in general, the criteria for determining interfering subchannels can be based on any applicable heuristic.

When the AP enters block 504 from monitoring mode (block 502) to begin a round of assessing the quality of the operating channel, the AP can assess every subchannel in the original full bandwidth of the operating channel. In this way, changes in the channel conditions in the original bandwidth can be re-assessed with each round, allowing the channel configuration of the operating channel to change as channel conditions change. For example, any previously removed subchannels can be returned for participation in the operating channel if their channel conditions have sufficiently improved since the previous assessment round and, conversely, any currently participating subchannels can be removed from participating in the operating channel if their channel conditions have sufficiently degraded since the previous round.

If there are no interfering subchannels in the original full bandwidth of the operating channel, the AP can proceed with processing in block 504a to restore the operation channel to its full bandwidth, for example, by resetting the puncture pattern to no puncturing and setting the bandwidth of the operating channel to its original bandwidth. The AP can proceed with processing in block 532 to announce the channel configuration.

On the other hand, if the AP determines there are interfering subchannels in the current bandwidth of the operating channel, the AP can proceed with processing in block 506 to initiate a selection loop 522 in accordance with the present disclosure to find a channel configuration for the operation channel that can avoid the interfering subchannels. Selection loop 522 begins with selecting a puncture pattern to cover the interfering subchannels (block 506).

At block 506, the AP can select a valid puncture pattern that is defined in accordance with Wi-Fi 7 that covers as many interfering subchannels as possible. The AP can proceed with processing in block 508 to determine if there are any remaining interfering subchannels, taking into account the selected puncture pattern.

At block 508, the AP can determine if there are any interfering subchannels (e.g., such as described in block 504) in the resulting non-punctured subchannels when the puncture pattern (selected in block 506) is applied to the current bandwidth. If there are interfering subchannels, the AP can proceed with processing in block 510 to continue with the selection loop 522 to find another channel configuration. If there are no interfering subchannels in the current bandwidth, the selection loop 522 terminates and the AP can proceed with processing in block 532 to announce any change in the channel configuration.

At block 510, if the current bandwidth of the operating channel is not at a minimum, the AP can reduce the current bandwidth by one half. The half of the bandwidth that contains the primary channel can be referred to as the primary half. The primary half becomes the new current bandwidth. The AP can proceed with processing in block 512 to determine if there are any interfering subchannels in the primary half.

On the other hand, if the current bandwidth of the operating channel is at a minimum, the selection loop 522 terminates and the AP can proceed to block 532 to announce any change in the channel configuration. In some embodiments, the minimum channel bandwidth can be the bandwidth of a single subchannel, in which case when the operating channel is at minimum bandwidth, the operating channel comprises a single subchannel, namely the primary channel itself. The current bandwidth of the operating channel is reduced by one half with each iteration of selection loop 522, until the minimum channel bandwidth is reached.

At block 512, the AP can determine if there are any interfering subchannels (e.g., such as described in block 504) in the primary half computed in block 510. If the AP determines there are interfering subchannels in the primary half, the AP can return to block 506 for another iteration of the selection loop 522 by selecting a puncture pattern to cover the interfering subchannels in the primary half. If there are no interfering subchannels in the current bandwidth, the AP can proceed with processing in block 532 to announce any change in the channel configuration.

At block 532, the AP can announce the configuration of the operating channel if the configuration has changed from the previous round of assessing the quality of the operating channel. If the configuration of the operating channel has not changed from the previous round, then the AP can simply return to block 502 to resume monitoring mode.

If the channel configuration has changed from the previous round of assessing channel quality, the AP can announce the new configuration of the operating channel to Clients. For example, the AP can announce the channel configuration (puncture pattern or channel bandwidth) in beacon frames that the AP regularly transmits. The AP can announce the channel configuration in probe response frames when responding to probe requests from Clients. The AP can announce the channel configuration in association response frames, in response to receiving association requests from Clients, and so on.

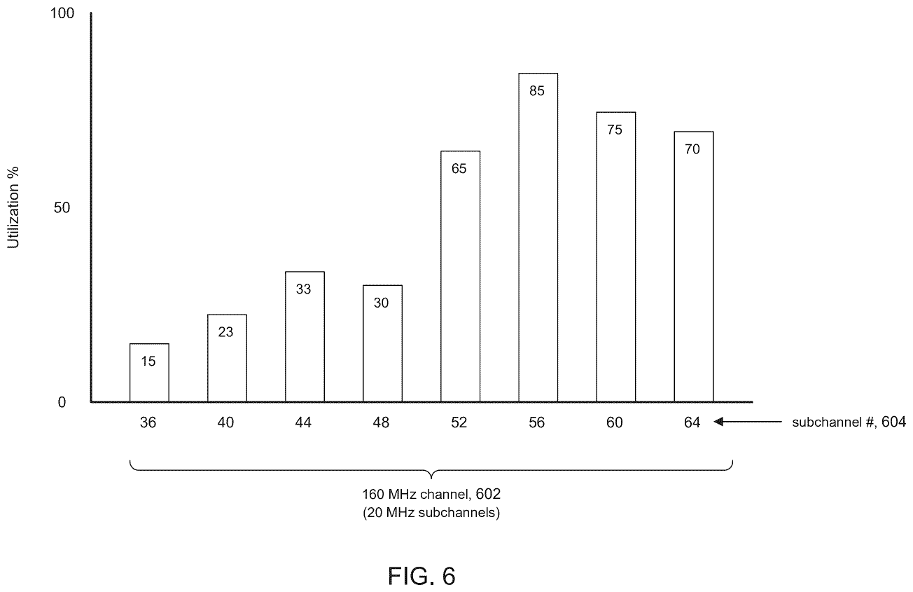

FIG. 6 shows an example of an operating channel to illustrate aspects of selection loop 522 in FIG. 5. The example operating channel is 160 MHz wide and comprises eight subchannels identified by subchannel numbers. Suppose the primary channel is subchannel 36. For purposes of discussion, the channel conditions for determining interfering subchannels is based on a utilization metric. The example shows that subchannels 56 and 60 have the highest utilization percentages, whereas subchannels 52 and 64 have medium utilization percentages and the remaining subchannels 36, 40, 44 and 48 have relatively low utilization percentages.

The selection loop can begin with the current bandwidth being 160 MHz and comprising all eight subchannels 36, 40, 44, 48, 52, 56, 60, and 64. The AP selects a valid Wi-Fi 7 puncture pattern (block 506). In the case of a 160 MHz channel bandwidth, Wi-Fi 7 allows for a maximum puncturing of 40 MHz. Therefore, the AP can select two subchannels with the highest utilization percentage, which in the example are subchannels 56 and 60. The AP selects the Wi-Fi 7 puncture pattern that punctures subchannels 56 and 60.

The AP can assess interference in the resulting non-punctured subchannels, namely subchannels 36, 40, 44, 48, 52, and 64 (block 508). The AP can determine that non-punctured subchannels 52 and 64 are deemed to be interfering subchannels. For example, the heuristic for determining interfering subchannels may say that the 65% and 70% utilization of subchannels 52 and 64, respectively, are still at risk for causing congestion.

The AP can reduce the current 160 MHz bandwidth of the operating channel (Y branch from block 508 to block 510). Because the current bandwidth is not at minimum (e.g., for discussion purposes, suppose 20 MHz is minimum), the AP can halve the current bandwidth of the operating channel from 160 MHz to 80 MHz. The primary half comprises subchannels 36 (primary channel), 40, 44, and 48.

The AP can assess interference in the primary half (block 512). If the heuristic for determining interfering subchannels does not deem subchannels 36, 40, 44, and 48 to be interfering, then the AP can announce the channel configuration of the 160 MHz operating channel to be 80 MHz wide (N branch from block 512 to block 532).

If, on the other hand, the heuristic determines subchannel 44 to be interfering. The AP repeats the selection loop (Y branch from block 512 to block 506) and selects a puncture pattern to puncture subchannel 44 from the 80 MHz bandwidth of the primary half. The processing continues to block 508 with the current bandwidth being 80 MHz and comprising subchannels 36, 40, 44 (punctured), and 48, and processing continues as described above.

### Preamble Puncture Nudging

The discussion will now turn to another aspect of the present disclosure referred to above as “preamble puncture nudging.” With preamble puncture nudging, a Wi-Fi 7-enabled AP receives an association request from a Client that is not enabled for Wi-Fi 7. Referring for a moment to FIG. 4C, when a non-Wi-Fi 7 Client associates with Wi-Fi 7 AP on a punctured channel, the Client can only use that portion of the bandwidth of the channel which includes the primary channel up to the first punctured subchannel closest to the primary channel. However, if the Client can transmit on a channel in another frequency band that the AP is also operating with and that channel is not punctured, then the AP can “nudge” the Client to transmit on that other channel in accordance with the present disclosure.

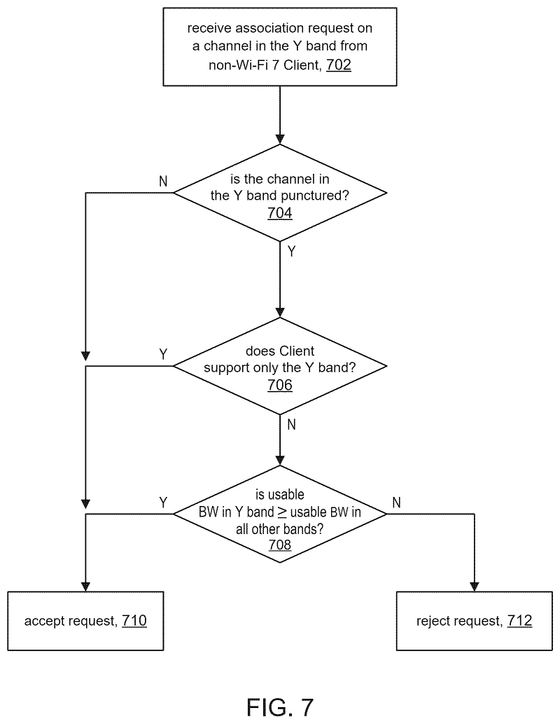

Referring to FIG. 7 the discussion will now turn to a high level description of processing in a Wi-Fi AP (FIG. 2) or in a Wi-Fi controller (FIG. 3) to accommodate non-Wi-Fi 7 Clients in accordance with the present disclosure. In some embodiments, for example, the AP can include computer executable program code (e.g., stored on a non-transitory computer-readable storage memory device), which when executed by a processor (e.g., 222, FIG. 2), can cause the computer system to perform the processing represented in FIG. 7. It will be appreciated that the processing blocks in FIG. 7 are merely representative of processing in accordance with the present disclosure. Actual operations and the flow and sequencing of those operations in a given implementation in accordance with the present disclosure will not necessarily correspond one-to-one with the processing blocks in FIG. 7.

At block 702, the Wi-Fi 7 AP can receive an association request from a non-Wi-Fi 7 Client. As described above, the AP may be configured with multiple radios so as to operate in multiple different frequency bands. The Wi-Fi standard defines 2.4 GHz, 5 GHz, and 6 GHz bands, for instance. The Client will transmit the association request on a channel in a frequency band of the AP, call it the Y band for discussion purposes.

It will be appreciated that in other embodiments, an AP may be configured with multiple radios that operate on the same frequency band but in different channels. The following operations can be readily adapted by persons of ordinary skill to support such a configuration.

At block 704, if the channel on which the association request was transmitted is not punctured, then the Client will be able to use the full bandwidth of the channel, and so the AP will accept the association request (block 710). On the other hand, if the channel is punctured, then in accordance with the present disclosure the AP can proceed to block 706 to determine if there is a channel that has more bandwidth than the channel on which the association request was transmitted.

At block 706, if the AP knows that the Client can transmit/receive only in the Y band, then the AP can accept the association request (block 710). On the other hand, if the AP operates in other frequency bands and the AP knows that the Client can operate in one of those other frequency bands, then the AP can proceed to block 708 to determine if there is more channel bandwidth in any of those other bands.

It is well understood that the AP can know of the Client's operating frequency bands and channels based on receiving various 801.11x frames from the Client. Briefly, for example, Clients can transmit probe request frames in multiple frequency bands and multiple channels to look for APs that are present. The AP can keep a record of the bands/channels on which the Clients transmitted the probe requests. Additionally, a Client can inform the AP of other bands/channels that the Client can operate with via data fields in the association request frame that the Client transmits to the AP.

At block 708, if the usable bandwidth of the punctured channel in the Y band is greater than or equal to the usable bandwidth of the channels (punctured or not) in each of the other bands that the Client can operate with, the AP can proceed to block 710 to accept the association request. On the other hand, if the usable bandwidth of a channel (punctured or not) in at least one of the other bands is greater than the usable bandwidth of the punctured channel in the Y band, the AP can proceed to block 712 to reject the association request.

In the case of a punctured channel, the “usable” bandwidth for a non-Wi-Fi 7 Client is the portion of the original bandwidth of the channel that includes the primary channel up to the first punctured subchannel closest to the primary channel. In the case of a non-punctured channel, the “usable” bandwidth is the full bandwidth of the channel.

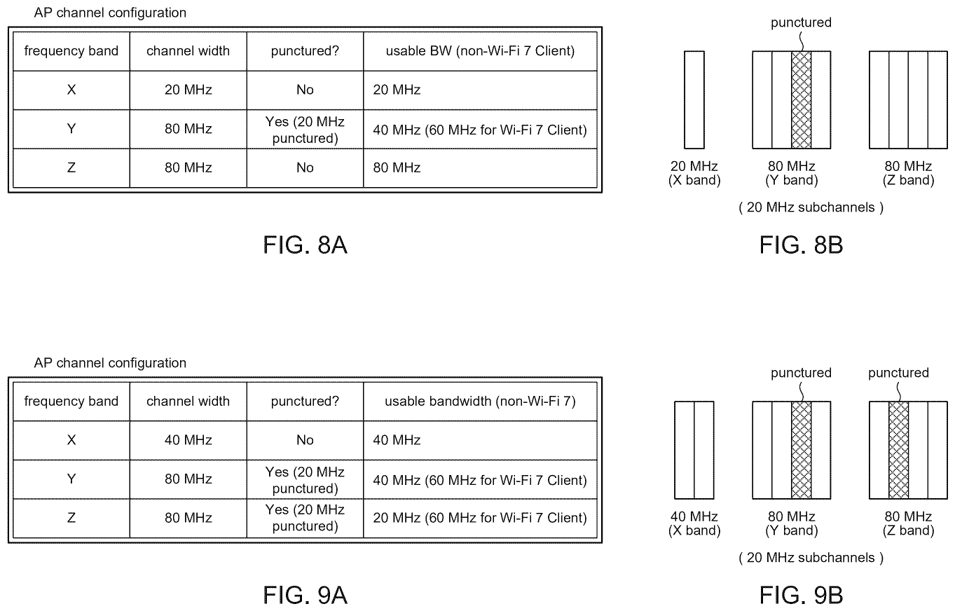

Consider, for example, the AP channel configuration represented in FIGS. 8A and 8B. The example channel configurations in FIG. 8B shows the third subchannel in the Y band channel is punctured, leaving a usable bandwidth of 40 MHz in the Y band for non-Wi-Fi 7 Clients. In this example, the usable bandwidth of the punctured channel in the Y band (40 MHz) is greater than the usable bandwidth of the channel in the X band (20 MHz) but is less than the usable bandwidth of the channel in the Z band (80 MHz), and so for this example the AP will reject the association request (N branch from block 708 to block 712).

Consider now the AP channel configuration example represented in FIGS. 9A and 9B. The example channel configurations in FIG. 9B shows two punctured channels, one in the Y band and one in the Z band. The third subchannel in the Y band channel is punctured, leaving a usable bandwidth of 40 MHz for non-Wi-Fi 7 Clients. The second subchannel in the Z band channel is punctured, leaving a usable bandwidth of 20 MHz in the Z band for non-Wi-Fi 7 Clients. In this example, the usable bandwidth of the punctured channel in the Y band (40 MHz) is greater than both the usable bandwidth of the channel in the X band (20 MHz) in the Z band (20 MHz), and so for this example the AP will accept the association request (Y branch from block 708 to block 710).

At block 710, the AP accepts the association request from the non-Wi-Fi 7 Client, for example, when the channel that the association request came in on is not punctured (N branch on block 704). When the channel is punctured, the AP will nevertheless accept the association request if the AP knows the Client can operate only on that channel (Y branch on block 706) and thus has no other choice. Likewise, when the channel is punctured and if the alternative bands do not offer a higher usable bandwidth than the punctured channel, the AP will accept the association request (Y branch on block 708).

At block 712, the AP rejects the association request from the non-Wi-Fi 7 Client when the usable bandwidth of the channel that the association request came in on is less than the usable bandwidth of a channel in one of the alternative bands (N branch in block 708). When the Client receives an association response from the AP that rejects the Client's association request, the Client can retry by sending another association request on a channel in a different band. By rejecting the association request, the AP in a sense “nudges” the Client to associate on a different channel, because the AP knows there is a channel in another band that has a higher usable bandwidth than the channel the original association request came in on. However, it is up to processing in the Client whether the Client retries at all or retries on another channel.

In some embodiments, in the case of a probe request, the AP can likewise “reject” the probe request when the usable bandwidth of the channel that the probe request came in on is less than the usable bandwidth of a channel in one of the alternative bands. Because there is no notion of a probe request rejection, in some embodiments the AP can choose not to respond to the probe request to nudge the Client to send a probe request on a different channel. When the Client times out waiting for a response from the probe request, the Client can retry by sending another probe request on a channel in a different band.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method in a wireless access point device (AP), the method comprising:
receiving an association request from a non-Wi-Fi 7 client device (Client) on an operating channel of the AP;
in response to the operating channel being not punctured, accepting the association request, wherein the client and the AP communicate on the operating channel; and
in response to the operating channel being punctured:
accepting the association request only when a usable bandwidth of the punctured channel is equal to or greater than a usable bandwidth of all alternate channels that the Client can operate with, wherein the client and the AP communicate on the punctured channel; and
rejecting the association request only when the usable bandwidth of the punctured channel is less than a usable bandwidth of at least one of the alternate channels that the Client can operate with.

2. The method of claim 1, further comprising, in response to the operating channel being punctured, accepting the association request only when the Client can only operate with the operating channel.

3. The method of claim 1, further comprising learning of the alternate channels from probe request frames transmitted by the Client on the alternate channels.

4. The method of claim 1, wherein the association request specifies the alternate channels.

5. The method of claim 4, wherein each of the alternate channels specified in the association request is in one of a 2.4 GHz frequency band, a 5 GHz frequency band, or a 6 GHz frequency band.

6. The method of claim 1, wherein subsequent to rejecting the association request, receiving from the client a subsequent association request on one of the alternate channels.

7. The method of claim 1, wherein the operating channel of the AP is in one of a 2.4 GHz frequency band, a 5 GHz frequency band, or a 6 GHz frequency band.

8. A non-transitory computer-readable storage device in an access point device (AP), the non-transitory computer-readable storage device having stored thereon computer executable instructions, which when executed, cause the AP to:
receive an association request from a non-Wi-Fi 7 client device (Client) on an operating channel of the AP;
in response to the operating channel being not punctured, accept the association request, wherein the client and the AP communicate on the operating channel; and
in response to the operating channel being punctured:
accept the association request when a usable bandwidth of the punctured channel is equal to or greater than a usable bandwidth of all alternate channels that the Client can operate with, wherein the client and the AP communicate on the punctured channel; and
reject the association request when the usable bandwidth of the punctured channel is less than a usable bandwidth of at least one of the alternate channels that the Client can operate with.

9. The non-transitory computer-readable storage device of claim 8, wherein the computer executable instructions, which when executed, further cause the AP to accept the association request when the operating channel is punctured and the Client can only operate with the operating channel.

10. The non-transitory computer-readable storage device of claim 8, wherein the computer executable instructions, which when executed, further cause the AP to learn of the alternate channels from probe request frames transmitted by the Client on the alternate channels.

11. The non-transitory computer-readable storage device of claim 8, wherein the association request specifies the alternate channels.

12. The non-transitory computer-readable storage device of claim 11, wherein each of the alternate channels specified in the association request is in one of a 2.4 GHz frequency band, a 5 GHz frequency band, or a 6 GHz frequency band.

13. The non-transitory computer-readable storage device of claim 8, wherein subsequent to rejecting the association request, receiving from the client a subsequent association request on one of the alternate channels.

14. The non-transitory computer-readable storage device of claim 8, wherein the operating channel of the AP is in one of a 2.4 GHz frequency band, a 5 GHz frequency band, or a 6 GHz frequency band.

15. A wireless access point device (AP) comprising:
one or more computer processors; and
a computer-readable storage device comprising instructions for controlling the one or more computer processors to:
receiving an association request from a non-Wi-Fi 7 client device (Client) on an operating channel of the AP;
in response to the operating channel being not punctured, accepting the association request, wherein the client and the AP communicate on the operating channel; and
in response to the operating channel being punctured, accepting the association request or rejecting the association request based on a usable bandwidth of the punctured operating channel.

16. The wireless access point device of claim 15, wherein the computer-readable storage device further comprises instructions for controlling the one or more computer processors to accept the association request when both the operating channel is punctured and the Client can only operate with the operating channel.

17. The wireless access point device of claim 15, wherein the computer-readable storage device further comprises instructions for controlling the one or more computer processors to accept the association request when both the operating channel is punctured and the usable bandwidth of the punctured channel is equal to or greater than a usable bandwidth of all alternate channels that the Client can operate with.

18. The wireless access point device of claim 17, wherein the alternate channels are learned from probe requests transmitted by the Client or in the association request.

19. The wireless access point device of claim 15, wherein the computer-readable storage device further comprises instructions for controlling the one or more computer processors to reject the association request when both the operating channel is punctured and the usable bandwidth of the punctured channel is less than a usable bandwidth of at least one of the alternate channels that the Client can operate with.

20. The wireless access point device of claim 19, wherein the alternate channels are learned from probe requests transmitted by the Client or in the association request.
